(19) United States
(12) Patent Application Publication
(10) Pub. No.: US 2026/0177227 A1
(43) Pub. Date: Jun. 25, 2026

(54) LIGHT-EMITTING DEVICE AND DISPLAY DEVICE

(71) Applicant: NICHIA CORPORATION, Anan-shi (JP)

(72) Inventors: Tomotoshi TSUJI, Suwa-shi (JP); Takashi SASAMURO, Chino-shi (JP); Takanori ARUGA, Suwa-gun (JP); Wataru KITAHARA, Kamiina-gun (JP)

(73) Assignee: NICHIA CORPORATION, Anan-shi (JP)

(21) Appl. No.: 19/428,928

(22) Filed: Dec. 22, 2025

(30) Foreign Application Priority Data
Dec. 24, 2024 (JP) 2024-228017

(51) Int. Cl. F21V 13/04; F21V 7/00

(52) U.S. Cl. CPC F21V 13/04; F21V 7/0066

(57) ABSTRACT

A light-emitting device includes: a light source configured to emit laser light; a lens configured to collimate the laser light; and a light-reflecting part having a plurality of reflecting surfaces disposed at intervals in a traveling direction of collimated light transmitted through the lens, the plurality of reflecting surfaces being configured to reflect the collimated light in an intersecting direction to the traveling direction, such that a beam diameter of reflected light reflected off the plurality of reflecting surfaces is greater than a beam diameter of the collimated light.

### CROSS-REFERENCE TO RELATED APPLICATION

This application claims priority to Japanese Patent Application No. 2024-228017, filed on Dec. 24, 2024, the disclosure of which is hereby incorporated by reference in its entirety.

### TECHNICAL FIELD

The present disclosure relates to a light-emitting device and a display device.

### BACKGROUND

Light-emitting devices are used in display devices such as projectors. A known light-emitting device includes a laser light source (for example, see Japanese Patent Publication No. 2019-36638).

### SUMMARY

When a light-emitting device including a laser light source is used in a display device such as a projector, the incident angle of light from an optical member included in the display device to an image generation element tends to be small due to the inherently low etendue of laser light. Thus, it is desirable to increase the incident angle of light from the optical member to the image generation element.

An object of the present disclosure is to provide a technology that enables a light-emitting device including a light source that emits laser light to output laser light with an increased beam diameter.

A light-emitting device according to an aspect of the present disclosure includes:
a light source configured to emit laser light;
a lens configured to collimate the laser light; and a light-reflecting part having a plurality of reflecting surfaces disposed at intervals in a traveling direction of collimated light transmitted through the lens, the plurality of reflecting surfaces being configured to reflect the collimated light in an intersecting direction to the traveling direction, in which a beam diameter of reflected light reflected off the plurality of reflecting surfaces is greater than a beam diameter of the collimated light.

A light-emitting device according to another aspect of the present disclosure includes:
a light source configured to emit laser light;
a lens configured to collimate the laser light; and
a light-reflecting part having a plurality of reflecting surfaces disposed at intervals in a traveling direction of collimated light transmitted through the lens, the plurality of reflecting surfaces being configured to reflect the collimated light in an intersecting direction to the traveling direction, in which a length of a region irradiated with the collimated light emitted to the plurality of reflecting surfaces along the traveling direction is greater than a length of the lens along the intersecting direction.

According to the present disclosure, laser light with an increased beam diameter can be output from a light-emitting device including a light source that emits laser light.

### BRIEF DESCRIPTION OF DRAWINGS

FIG. 1 is a schematic plan view illustrating a light-emitting device and a display device according to a first embodiment.

FIG. 2 is a schematic plan view illustrating an incident angle of laser light relative to an image generation element included in the display device according to the first embodiment.

FIG. 3 is a schematic cross-sectional view illustrating the light-emitting device according to the first embodiment.

FIG. 4 is a schematic cross-sectional view illustrating the light-emitting device according to the first embodiment.

FIG. 5 is a schematic perspective view illustrating a region irradiated with collimated light emitted to a light-reflecting part of the light-emitting device according to the first embodiment.

FIG. 6 is a schematic plan view illustrating a light-emitting device and a display device according to a second embodiment.

FIG. 7A is a schematic cross-sectional view illustrating the light-emitting device according to the second embodiment.

FIG. 7B is a schematic enlarged side view of a light-reflecting part in FIG. 7A.

FIG. 8 is a schematic cross-sectional view illustrating the light-emitting device according to the second embodiment.

FIG. 9 is a schematic plan view illustrating a light-emitting device and a display device according to a third embodiment.

FIG. 10 is a schematic plan view illustrating the light-emitting device according to the third embodiment.

FIG. 11 is a schematic cross-sectional view taken along line 11X-11X in FIG. 10.

FIG. 12 is a schematic plan view illustrating a modification example of the light-emitting device according to the third embodiment.

FIG. 13 is a schematic cross-sectional view illustrating a light-emitting device according to another embodiment.

FIG. 14 is a schematic cross-sectional view illustrating a light-emitting device according to another embodiment.

FIG. 15 is a schematic cross-sectional view illustrating a light-emitting device according to another embodiment.

### DETAILED DESCRIPTION

Embodiments of the present disclosure will be described below with reference to the drawings. In the drawings, the same reference characters are used to designate the same or similar constituent elements. In the following embodiments, redundant descriptions and reference characters may be omitted. The drawings used in the following description are all schematic, and the dimensional relationship between elements, the ratio of elements, and the like illustrated in the drawings do not necessarily match the actual ones. The dimensional relationship between elements, the ratio of elements, and the like are not necessarily consistent throughout the drawings.

### First Embodiment

A light-emitting device 30 and a display device 20 according to the first embodiment of the present disclosure will now be described.

### Display Device 20

First, the display device 20 is described.

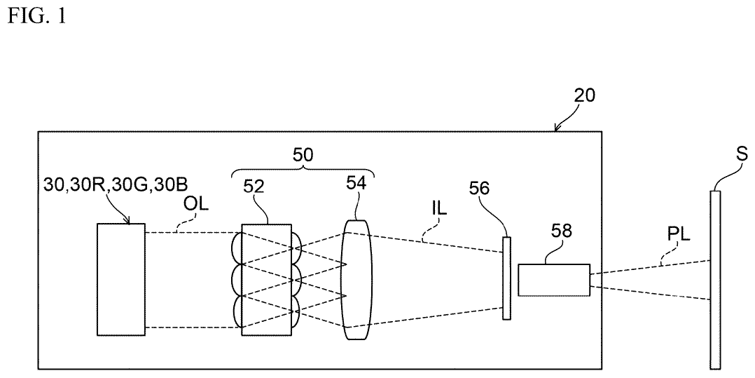

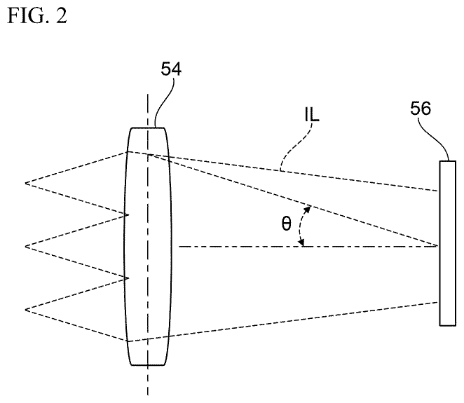

FIG. 1 is a schematic plan view illustrating the light-emitting device 30 and the display device 20 according to the present embodiment. FIG. 2 is a schematic plan view illustrating an incident angle θ of laser light relative to an image generation element 56 included in the display device 20 according to the present embodiment.

The display device 20 of the present embodiment is a device having a function of displaying an image on a target S. The display device 20 is, for example, a projector, a head-up display, a head-mounted display, or a glasses-type wearable device.

As illustrated in FIG. 1, the display device 20 includes the light-emitting device 30, an optical system 50, the image generation element 56, and an imaging optical member 58.

The light-emitting device 30 is a device that outputs laser light OL. The display device 20 of the present embodiment includes a plurality of light-emitting devices 30 that output the laser light OL having different wavelengths.

Specifically, the display device 20 includes three light-emitting devices 30. The three light-emitting devices 30 are, for example, a light-emitting device 30R that outputs red laser light, a light-emitting device 30G that outputs green laser light, and a light-emitting device 30B that outputs blue laser light. The three light-emitting devices 30 have the same configuration except for the light source that emits laser light. Thus, when the three light-emitting devices 30 are individually described, R (red), G (green), and B (blue) indicating the colors of the laser light are added to the respective configurations. When a configuration common to the three light-emitting devices 30 is described, the description will be made without adding R, G, and B. The light-emitting device 30 will be described below in detail.

The optical system 50 has a function of causing the angular intensity distribution of the laser light OL output from the light-emitting device 30 to be more uniform, and a function of condensing the laser light having a more uniform angular intensity distribution toward the image generation element 56. The optical system 50 of the present embodiment includes a fly-eye lens 52 and a light-condensing lens 54. In the present embodiment, the laser light OL output from the light-emitting device 30 is transmitted through the optical system 50 and is emitted to (incident on) the image generation element 56. Specifically, the laser light OL becomes a more uniform angular intensity distribution by the fly-eye lens 52, and is condensed at the image generation element 56 by the light-condensing lens 54. Hereinafter, the laser light that is condensed by the light-condensing lens 54 and is emitted to the image generation element 56 is referred to as irradiation light IL. As illustrated in FIG. 2, the incident angle θ of the irradiation light IL relative to the image generation element 56 is within a range of 10 degrees to 30 degrees.

The optical system 50 of the present embodiment includes the fly-eye lens 52 having a function of causing the angular intensity distribution of the laser light OL to be uniform, but another optical member may be used instead of the fly-eye lens 52 as long as the angular intensity distribution of the laser light OL can become more uniform. Examples of another optical member include an integrating rod and a diffuser. Further, as the optical system 50, any two of the fly-eye lens 52, an integrating rod, and a diffuser may be used, or a combination of all of them may be used.

The image generation element 56 is an element on which the laser light output from the light-emitting device 30 is incident. Specifically, the image generation element 56 is irradiated with the irradiation light IL which is laser light condensed by the light-condensing lens 54. The image generation element 56 includes, for example, a plurality of optical switches. The image generation element 56 may include, for example, an element based on micro electro mechanical systems (MEMS). The image generation element 56 is irradiated with the irradiation light IL, and thus light for generating an image to be displayed on the target S is obtained.

The imaging optical member 58 is a member having a function of forming an image from the light emitted from the image generation element 56. The imaging optical member 58 includes, for example, a projection lens. The light emitted from the image generation element 56 is formed as an image on the target S by the imaging optical member 58. In this manner, an image is displayed on the target S. In FIG. 1, the light (projection light) projected from the imaging optical member 58 onto the target S is denoted by reference character PL.

### Light-Emitting Device 30

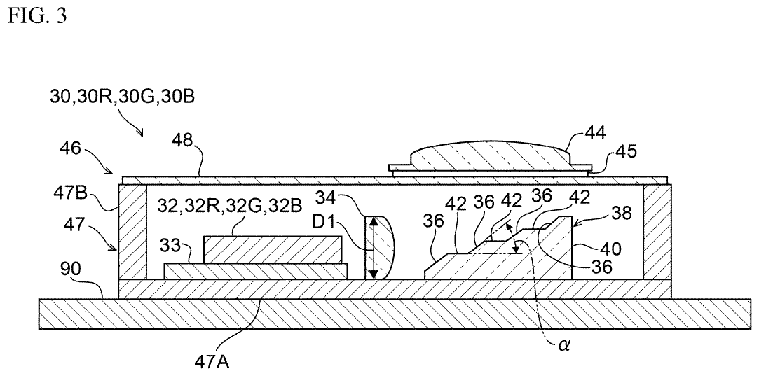

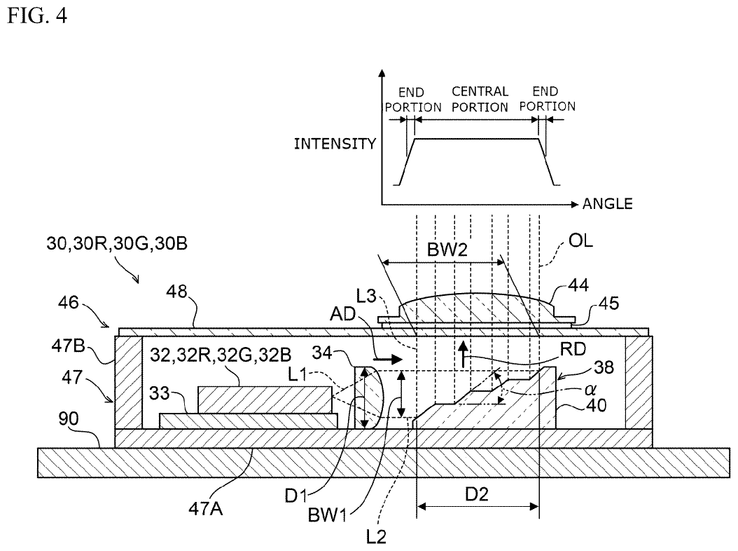

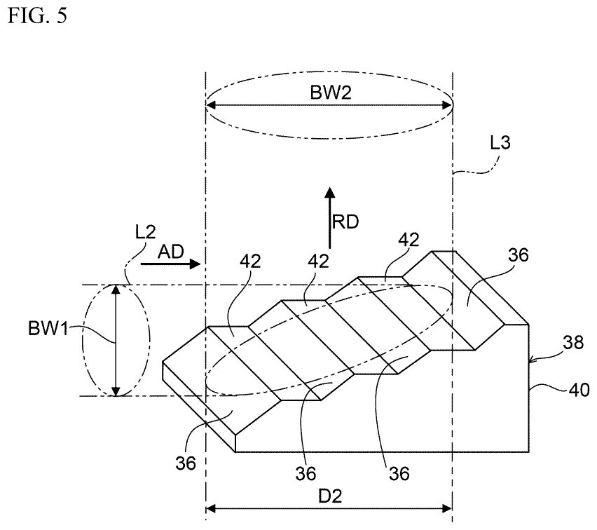

The light-emitting device 30 is now described in detail. FIGS. 3 and 4 are schematic cross-sectional views illustrating the light-emitting device 30 according to the present embodiment. The angular intensity distribution of the output laser light OL is illustrated in the upper part of the drawing of FIG. 4. FIG. 5 is a schematic perspective view illustrating a region irradiated with collimated light L2 emitted to a light-reflecting part 38 of the light-emitting device 30 according to the present embodiment.

As illustrated in FIGS. 3 and 4, the light-emitting device 30 of the present embodiment includes a light source 32, a first lens 34, and the light-reflecting part 38.

As illustrated in FIG. 4, the light source 32 is a semiconductor laser that emits laser light L1. The light source 32 of the present embodiment uses an edge-emitting semiconductor laser, for example. Thus, the laser light L1 has an elliptical far field pattern (hereinafter, referred to as “FFP”). That is, the laser light L1 is an elliptical beam, and the major axis of the ellipse is along the vertical direction of the drawing of FIG. 4.

The light source 32R included in the light-emitting device 30R emits red laser light L1 having a peak wavelength in a range from 605 nm to 750 nm. The light source 32G included in the light-emitting device 30G emits green laser light L1 having a peak wavelength in a range from 495 nm to 570 nm.

The light source 32B included in the light-emitting device 30B emits blue laser light L1 having a peak wavelength in a range from 420 nm to 494 nm.

As illustrated in FIG. 4, the first lens 34 is a collimator lens that collimates the laser light L1. To be specific, the first lens 34 collimates the elliptical laser light L1 at least in the major axis direction. The expression “collimate the laser light” used here may include convergence and divergence of the laser light within a tolerance range. The collimated laser light (collimated light) includes, for example, light that converges and diverges within a range of about ±3 degrees as a tolerance range. The first lens 34 may collimate the elliptical laser light L1 in the major axis direction and the minor axis direction. The cross-sectional shape of the collimated light L2 collimated by the first lens 34 is an elliptical shape that is the same as or similar to that of the laser light L1. The first lens 34 may include, for example, resin, glass, or quartz.

As illustrated in FIG. 4, the light-reflecting part 38 is a part of the light-emitting device 30 and has a function of reflecting the collimated light L2 transmitted through the first lens 34 to make a beam diameter BW2 of reflected light L3 greater than a beam diameter BW1 of the collimated light L2. As illustrated in FIG. 5, the beam diameter BW1 of the collimated light L2 is the length in the major axis direction, that is, the long diameter. The beam diameter BW2 of the reflected light L3 is the length in the major axis direction, that is, the long diameter.

As illustrated in FIGS. 3 and 4, the light-reflecting part 38 of the present embodiment includes a plurality of reflecting surfaces 36. The plurality of reflecting surfaces 36 are disposed at intervals in the traveling direction of the collimated light L2. The traveling direction of the collimated light L2 is indicated by an arrow AD in FIG. 4.

The plurality of reflecting surfaces 36 reflect the collimated light L2 in a direction intersecting the traveling direction AD. In the present embodiment, the plurality of reflecting surfaces 36 reflect the collimated light L2 in a direction orthogonal to the traveling direction AD. The traveling direction of the reflected light L3 reflected off the plurality of reflecting surfaces 36 is indicated by an arrow RD in FIG. 4. In the present embodiment, the traveling direction AD of the collimated light L2 and the traveling direction RD of the reflected light L3 are orthogonal to each other.

In the present embodiment, inclination angles α of the plurality of reflecting surfaces 36 relative to the traveling direction AD are identical. The expression “the inclination angles are identical” used here includes a tolerance within about ±3 degrees. The inclination angle α is set to 45 degrees, for example. Setting the inclination angle α to 45 degrees enables the collimated light L2 to be reflected in a direction orthogonal to the traveling direction AD.

As illustrated in FIG. 5, when the elliptical collimated light L2 is reflected off the plurality of reflecting surfaces 36 disposed at intervals in the traveling direction AD, the long diameter increases. Thus, the beam diameter BW2 of the reflected light L3, which is the collimated light reflected off the plurality of reflecting surfaces 36, is greater than the beam diameter BW1 of the collimated light L2.

In the present embodiment, as an example, as illustrated in FIG. 4, a length D2 of the region irradiated with the collimated light L2 emitted to the plurality of reflecting surfaces 36 along the traveling direction AD is greater than a length D1 of the first lens 34 along the direction orthogonal to the traveling direction AD. Here, the length D2 of the region irradiated with the collimated light L2 is a length measured along the traveling direction AD from a point first irradiated with the collimated light L2 to a point last irradiated with the collimated light L2 in the region irradiated with the collimated light L2, as illustrated in FIGS. 4 and 5. The length D1 of the first lens 34 along the direction orthogonal to the traveling direction AD is the length of the first lens 34 along the traveling direction RD of the reflected light L3 in FIG. 4. When the first lens 34 is a circular lens, the length D1 is the diameter of the first Lens 34.

As illustrated in FIGS. 3 and 4, the light-reflecting part 38 may be formed as a reflecting member 40 including the plurality of reflecting surfaces 36. The reflecting member 40 includes connecting surfaces 42 extending in the traveling direction AD and connecting the reflecting surfaces 36 adjacent to each other. The expression “extending in the traveling direction” used here includes a direction inclined by about ±5 degrees relative to the traveling direction AD.

Further, it is preferable that the inclination angle of the connecting surface 42 relative to the traveling direction AD is an angle at which the collimated light L2 is not reflected. An angle at which the collimated light L2 is not reflected means an angle of 0 degrees (parallel) or a negative angle relative to the collimated light L2.

In the present embodiment, the lengths of the connecting surfaces 42 along the traveling direction AD are the same.

In other words, the plurality of reflecting surfaces 36 are disposed at equal intervals in the traveling direction AD.

The present disclosure is not limited to the configuration described above. For example, the lengths of the adjacent connecting surfaces 42 along the traveling direction AD may be different from each other.

As an example, the reflecting member 40 of the present embodiment includes four reflecting surfaces 36 and three connecting surfaces 42.

The reflecting member 40 may include, for example, resin, glass, or quartz. The reflecting surface 36 may include a material having a high reflectance such as metal.

As illustrated in FIGS. 3 and 4, the light-emitting device 30 further includes a second lens 44 and a housing 46.

As illustrated in FIG. 4, the second lens 44 is a lens having a function of outputting the reflected light L3 with an angular intensity distribution becoming more uniform. As the lens having a function of outputting light with an angular intensity distribution becoming more uniform, for example, a lens having the structure disclosed in Japanese Patent Publication No. 2021-81701 may be used. The second lens 44 may include, for example, resin, glass, or quartz. The reflected light L3 incident on the second lens 44 is output with an angular intensity distribution becoming more uniform through the second lens 44. The light output from the second lens 44 becomes the laser light OL output from the light-emitting device 30.

As illustrated in FIG. 3, the housing 46 houses therein the light source 32, the first lens 34, and the reflecting member 40. Specifically, the housing 46 includes a box 47 with one side open and a lid 48 closing the open part of the box 47.

The box 47 includes a bottom portion 47A and a frame portion 47B. The box 47 and the lid 48 are components of the housing 46. In the present embodiment, as an example, the bottom portion 47A and the frame portion 47B are formed of different materials. The bottom portion 47A may be formed of a metal material such as Cu or Al, for example. The frame portion 47B may be formed of a ceramic such as alumina (Al₂O₃) or AlN, for example. In the present embodiment, the lid 48 is formed of a transparent material. Examples of the transparent material include resin, glass, and quartz. In the present embodiment, the lid 48 may have light transmissivity at least in a region through which the laser light OL is transmitted, and a light shielding film may be formed in a region through which the laser light is not transmitted. The light shielding film reduces the possibility that stray light other than the laser light L1 generated inside the light-emitting device 30 may leak to the outside of the light-emitting device 30. The light shielding film further reduces the possibility that return light of the laser light OL has been emitted to the outside of the light-emitting device 30 may reach the light source 32. When the irradiation by the return light can be reduced, damage to the light source 32 is suppressed.

The light source 32, the first lens 34, and the reflecting member 40 are fixed to the bottom portion 47A of the box 47. To be more specific, the light source 32 is fixed to the bottom portion 47A of the box 47 via a submount 33.

The lid 48 is provided with the second lens 44. Specifically, the second lens 44 is joined to the lid 48. More specifically, the second lens 44 is bonded to the lid 48 via an adhesive layer 45 formed of an adhesive. The adhesive layer 45 is disposed out of the optical path of the reflected light L3. The lid 48 is attached to the box 47 so as to seal the inside of the box 47. The present disclosure is not limited to the configuration described above, and the housing 46 may be compose of a plate-shaped base and a cover covering the base. In this case, the light source 32, the first lens 34, and the reflecting member 40 are fixed on the base, the second lens 44 is attached to the cover, and the cover and the base are attached so that the inside of the cover is sealed.

The light-emitting device 30 is mounted on a substrate 90. The light source 32 is electrically connected to an electrode layer (not illustrated) included in the substrate 90. The light source 32 emits the laser light L1 by being supplied with power through the electrode layer of the substrate 90.

The light-emitting devices 30R, 30G, and 30B may be mounted on separate substrates 90 or may be mounted on one substrate 90. The light-emitting device 30 may include the substrate 90.

An effect of the present embodiment is described below. As illustrated in FIG. 4, in the light-emitting device 30 of the present embodiment, the laser light L1 emitted from the light source 32 is collimated by the first lens 34. The collimated light L2 transmitted through the first lens 34 is reflected off the plurality of reflecting surfaces 36 of the light-reflecting part 38. Here, in the light-emitting device 30, the beam diameter BW2 of the reflected light L3 which is reflected off the plurality of reflecting surfaces 36 is greater than the beam diameter BW1 of the collimated light L2. Specifically, when the collimated light L2 is reflected off the plurality of reflecting surfaces 36 disposed at intervals in the traveling direction AD, the long diameter increases. That is, in the light-emitting device 30, the plurality of reflecting surfaces 36 are disposed at intervals in the traveling direction AD, so that for example, compared to a configuration in which one continuous reflecting surface 36 is provided, the length D2 of the region irradiated with the collimated light L2 is increased, and thus the beam diameter BW2 of the reflected light L3 is increased. In this manner, the light-emitting device 30 can output the laser light OL with an increased beam diameter. In the display device 20 of the present embodiment, the laser light OL with an increased beam diameter is output from the light-emitting device 30 without providing an expansion optical member such as an expander lens inside the display device 20, and thus it is possible to suppress an increase in cost due to an increase in the number of parts caused by providing the expansion optical member. In addition, the display device 20 can suppress an increase in size caused by providing the expansion optical member. In other words, the display device 20 does not include the expansion optical member, and thus can reduce the size.

In the light-emitting device 30 of the present embodiment, because one reflecting member 40 includes a plurality of reflecting surfaces 36, an increase in the number of parts can be suppressed as compared with a case in which reflecting members, each of which has one reflecting surface, are arranged at intervals in the traveling direction AD. In addition, high mounting accuracy is required to accurately arrange reflecting members, each of which has one reflecting surface, at intervals in the traveling direction AD. In contrast, in the light-emitting device 30 of the present embodiment, because the one reflecting member 40 has the plurality of reflecting surfaces 36, the relative positions of the reflecting surfaces 36 are determined, and it is easy to accurately dispose the plurality of reflecting surfaces 36 at intervals in the traveling direction AD.

In the light-emitting device 30 of the present embodiment, the beam diameter BW2 of the reflected light L3 can be increased by increasing the length of the connecting surface 42 in the traveling direction AD, that is, by increasing the interval between the adjacent reflecting surfaces 36. As described above, in the light-emitting device 30, the beam diameter BW2 of the reflected light L3 can be changed according to the length of the connecting surface 42 in the traveling direction AD, and thus a desired beam diameter can be obtained with a simple structure.

In the light-emitting device 30 of the present embodiment, the reflected light L3 reflected off the plurality of reflecting surfaces 36 is output with an angular intensity distribution becoming more uniform through the second lens 44. In this manner, in the light-emitting device 30, the reflected light L3 is transmitted through the second lens 44, and thus the laser light OL is output with the variation in the angular intensity distribution reduced. Thus, the angular intensity distribution of the laser light OL can be made more uniform. Because the angular intensity distribution of the laser light OL can be made more uniform, it is not necessary to dispose an optical member for achieving the uniform laser light between the light-emitting device 30 and the optical system 50 in the display device 20. This can contribute to reducing the size and cost of the display device 20. The term “uniform” used here is not limited to a completely uniform distribution, and includes a distribution that changes towards being “more uniform” compared to the original state.

In addition, in light-emitting device 30 of the present embodiment, the second lens 44 is attached to the lid 48 forming the housing 46. Here, the lid 48 of the present embodiment is formed of a glass material that can ensure the airtightness of the housing 46. On the other hand, the second lens 44 is formed of a glass material for exhibiting a function as a lens. The lid 48 and the second lens 44 which are formed of different glass materials are joined together, so that the light-emitting device 30 of the present embodiment can achieve both ensuring of airtightness of the housing 46 and the effect of achieving the uniform angular intensity distribution of the laser light OL.

As illustrated in FIG. 1, in the display device 20 of the present embodiment, because the beam diameter of the laser light OL output from the light-emitting device 30 is increased, the incident angle θ of the irradiation light IL to the image generation element 56 is increased. The incident angle θ is increased in this manner, so that generation of speckles in an image displayed on the target S by the display device 20 is reduced. Then, setting the incident angle θ relative to the image generation element 56 within a range of 10 degrees to 30 degrees makes it possible to effectively reduce speckles to be generated in the image displayed on the target S. When the incident angle θ is less than 10 degrees, the effect of reducing the speckles is insignificant. On the other hand, when the incident angle θ exceeds 30 degrees, it is necessary to reduce the F value of the imaging optical member 58. This may lead to a cost increase. Thus, the incident angle θ is preferably set within a range of 10 degrees to 30 degrees.

### Second Embodiment

A light-emitting device 130 and a display device 120 according to the second embodiment of the present disclosure will now be described. Configurations that are the same as those of the light-emitting device 30 and the display device 20 of the first embodiment will not be described.

### Display Device 120

First, the display device 120 is described.

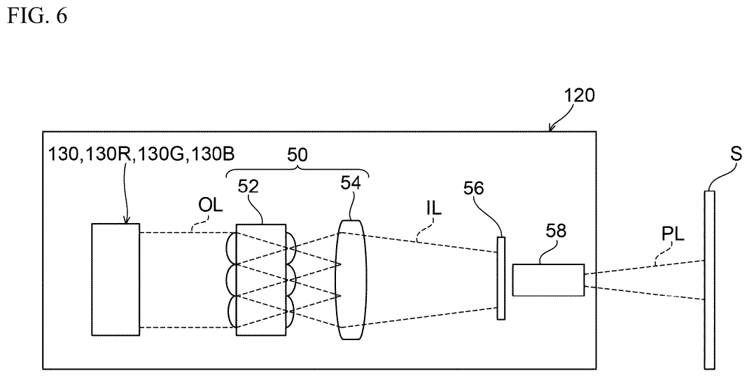

FIG. 6 is a schematic plan view illustrating the light-emitting device 130 and the display device 120 according to the present embodiment.

The display device 120 of the present embodiment includes the light-emitting device 130, the optical system 50, the image generation element 56, and the imaging optical member 58. The display device 120 of the present embodiment has the same configuration as the display device 20 of the first embodiment except for the light-emitting device 130. Similarly to the light-emitting device 30 of the first embodiment, the light-emitting device 130 includes three light-emitting devices 130. The three light-emitting devices 130 are, for example, a light-emitting device 130R that outputs red laser light, a light-emitting device 130G that outputs green laser light, and a light-emitting device 130B that outputs blue laser light. The three light-emitting devices 130 have the same configuration except for the light source that emits laser light. Thus, when the three light-emitting devices 130 are individually described, R (red), G (green), and B (blue), indicating the colors of the laser light are added to the respective configurations. When a configuration common to the three light-emitting devices 130 is described, the description will be made without adding R, G, and B.

### Light-Emitting Device 130

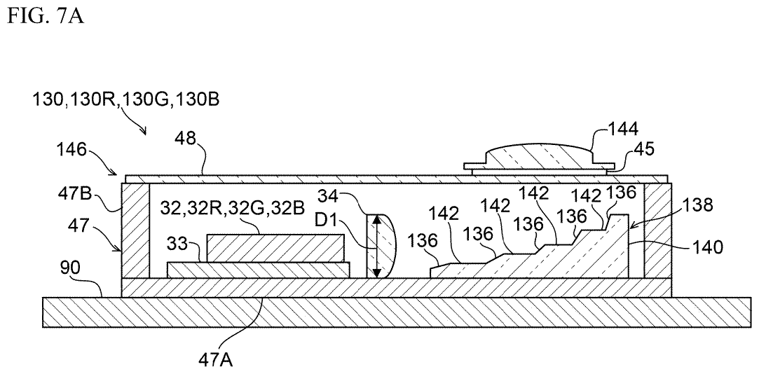

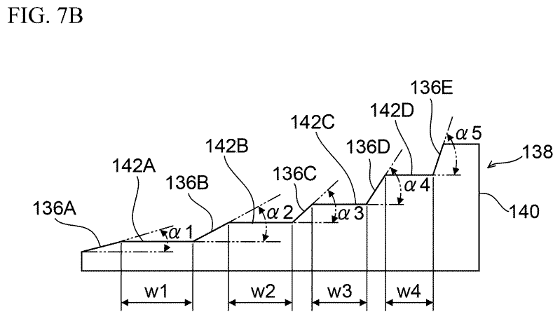

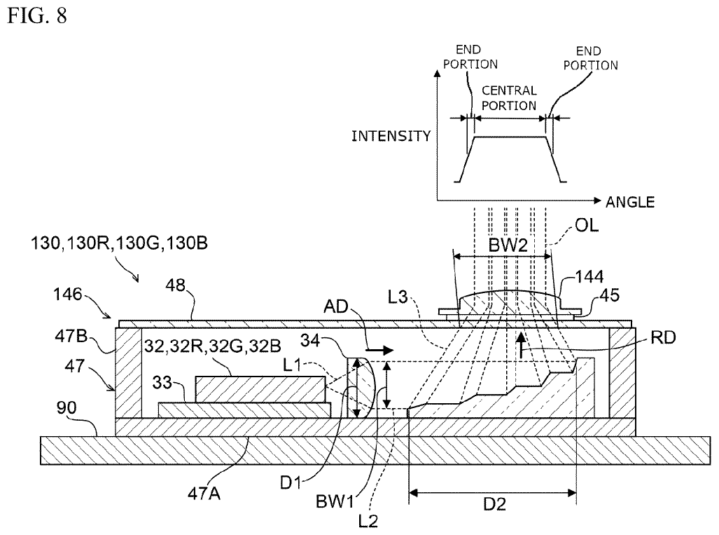

The light-emitting device 130 is now described in detail. FIG. 7A is a schematic cross-sectional view illustrating the light-emitting device 130 according to the present embodiment. FIG. 7B is a schematic enlarged side view of a light-reflecting part in FIG. 7A. FIG. 8 is a schematic cross-sectional view illustrating the light-emitting device 130 according to the present embodiment. The angular intensity distribution of the output laser light OL is illustrated in the upper part of the drawing of FIG. 8.

As illustrated in FIGS. 7A and 8, the light-emitting device 130 of the present embodiment includes the light source 32, the first lens 34, and a light-reflecting part 138. Also, the light-emitting device 130 further includes a second lens 144 and a housing 146.

As illustrated in FIG. 8, the light-reflecting part 138 is a part of the light-emitting device 130, and has a function of reflecting the collimated light L2 transmitted through the first lens 34 to make the beam diameter BW2 of the reflected light L3 greater than the beam diameter BW1 of the collimated light L2.

As illustrated in FIG. 7A, the light-reflecting part 138 of the present embodiment includes a plurality of reflecting surfaces 136. The plurality of reflecting surfaces 136 are disposed at intervals in the traveling direction AD of the collimated light L2.

The plurality of reflecting surfaces 136 reflect the collimated light L2 in a direction intersecting the traveling direction AD. In the present embodiment, the plurality of reflecting surfaces 136 reflect the collimated light L2 in different directions. The traveling direction of the reflected light L3 reflected off the plurality of reflecting surfaces 136 is indicated by an arrow RD in FIG. 8. In the present embodiment, the traveling direction AD of the collimated light L2 and the traveling direction RD of the reflected light L3 are orthogonal to each other.

As illustrated in FIG. 7B, in the present embodiment, the inclination angles α of the plurality of reflecting surfaces 136 relative to the traveling direction AD are different angles. The expression “inclination angles are different” used here includes a case in which the inclination angles are different by a tolerance range or greater. Being different by a tolerance range or greater means that the angle difference is equal to or greater than 3 degrees, for example.

The inclination angles α of the plurality of reflecting surfaces 136 gradually increase along the traveling direction AD from the side closer to the first lens 34. In the present embodiment, as an example, the light-reflecting part 138 includes five reflecting surfaces 136. In FIG. 7B, the five reflecting surfaces 136 are denoted by reference characters 136A, 136B, 136C, 136D, and 136E in order from the side closer to the first lens 34. In the present embodiment, when the inclination angle of the reflecting surface 136A is α1, the inclination angle of the reflecting surface 136B is α2, the inclination angle of the reflecting surface 136C is α3, the inclination angle of the reflecting surface 136D is α4, and the inclination angle of the reflecting surface 136E is α5, a relationship of α1<α2<α3<α4<α5 is established.

As illustrated in FIG. 8, when the elliptical collimated light L2 is reflected off the plurality of reflecting surfaces 136 disposed at intervals in the traveling direction AD, the long diameter increases. Thus, the beam diameter BW2 of the reflected light L3 which is the collimated light reflected off the plurality of reflecting surfaces 136 is greater than the beam diameter BW1 of the collimated light L2.

In the present embodiment, as an example, as illustrated in FIG. 8, the length D2 of the region irradiated with the collimated light L2 emitted to the plurality of reflecting surfaces 136 along the traveling direction AD is greater than the length D1 of the first lens 34 along the direction orthogonal to the traveling direction AD.

The light-reflecting part 138 may be formed as a reflecting member 140 including the plurality of reflecting surfaces 136. The reflecting member 140 includes connecting surfaces 142 extending in the traveling direction AD and connecting the reflecting surfaces 136 adjacent to each other.

In the present embodiment, lengths W of the connecting surfaces 142 along the traveling direction AD are different lengths. In other words, the plurality of reflecting surfaces 136 are disposed at different intervals in the traveling direction AD. Specifically, the lengths W of the connecting surfaces 142 gradually decrease along the traveling direction AD from the side closer to the first lens 34. In the present embodiment, as an example, the light-reflecting part 138 includes four connecting surfaces 142. The four connecting surfaces 142 are denoted by reference characters 142A, 142B, 142C, and 142D in order from the side closer to the first lens 34. In the present embodiment, when the length of the connecting surface 142A is denoted by W1, the length of the connecting surface 142B is denoted by W2, the length of the connecting surface 142C is denoted by W3, and the length of the connecting surface 142D is denoted by W4, a relationship of W1>W2>W3>W4 is established.

The reflecting member 140 may include, for example, resin, glass, or quartz. The reflecting surface 136 may include a material having a high reflectance such as metal.

The second lens 144 is a collimator lens that collimates the reflected light L3. The second lens 144 may include, for example, resin, glass, or quartz. The reflected light L3 incident on the second lens 144 is collimated by the second lens 144 and output. The output light output from the second lens 144 becomes the laser light OL output from the light-emitting device 130.

The housing 146 houses therein the light source 32, the first lens 34, and the reflecting member 140. Also, the housing 146 includes the box 47 and the lid 48 closing the opened part of the box 47. The lid 48 is provided with the second lens 144. Specifically, the second lens 144 is bonded to the lid 48 via the adhesive layer 45 formed of an adhesive. The lid 48 is attached to the box 47 so as to seal the inside of the box 47. The present disclosure is not limited to the configuration described above, and the housing 146 may be compose of a plate-shaped base and a cover covering the base.

The light-emitting device 130 is mounted on the substrate 90. The light source 32 is electrically connected to an electrode layer (not illustrated) included in the substrate 90. The light source 32 emits the laser light L1 by being supplied with power through the electrode layer of the substrate 90. The light-emitting devices 130R, 130G, and 130B may be mounted on separate substrates 90 or may be mounted on one substrate 90. The light-emitting device 130 may include the substrate 90.

An effect of the light-emitting device 130 of the present embodiment is described below. Effects obtained by the same configuration as the configuration of the first embodiment will not be described.

In the light-emitting device 130 of the present embodiment, the collimated light L2 is reflected in different directions by the plurality of reflecting surfaces 136. Thus, in the light-emitting device 130, the angular intensity distribution of the laser light OL, which is the reflected light L3 transmitted through the second lens 144, can become more uniform without disposing a lens that causes the angular intensity distribution to be more uniform, as compared with the case in which the inclination angles α of the plurality of reflecting surfaces are identical. Thus, as illustrated in the angular intensity distribution in the upper part of FIG. 8, the difference in intensity between the central portion and the end portion of the laser light OL falls within 20%. 5% to 10% of the range of the second lens 144 from the lens end corresponds to the end portion described above, and 80% of the range of the second lens 144, including the center, corresponds to the central portion described above. In the light-emitting device 130, because the laser light OL is output with the angular intensity distribution in which the difference in intensity between the end portion and the central portion falls within 20%, it is possible to effectively reduce speckles to be generated when an image is displayed on the target S. Further, because the display device 120 includes the light-emitting device 130, it is not necessary to include an optical system such as a fly-eye lens for achieving the uniform intensity distribution, and thus it is possible to reduce the number of parts and to reduce the size.

### Third Embodiment

A light-emitting device 230 and a display device 220 according to the third embodiment will now be described. Configurations that are the same as those of the light-emitting device 30 and the display device 20 of the first embodiment will not be described.

### Display Device 220

First, the display device 220 is described.

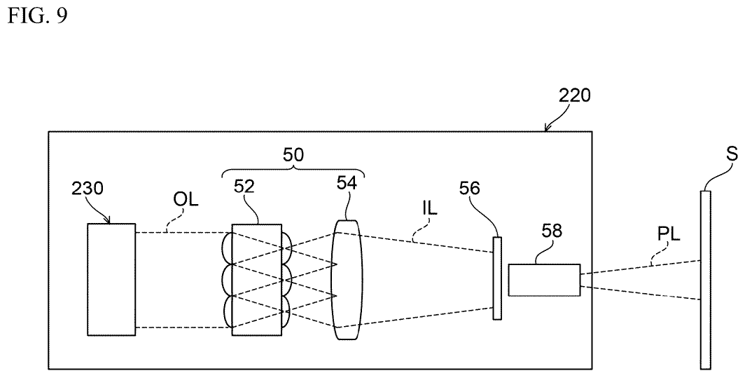

FIG. 9 is a schematic plan view illustrating the light-emitting device 230 and the display device 220 according to the present embodiment.

The display device 220 of the present embodiment includes the light-emitting device 230, the optical system 50, the image generation element 56, and the imaging optical member 58. The display device 220 of the present embodiment has the same configuration as the display device 20 of the first embodiment except for the light-emitting device 230.

### Light-Emitting Device 230

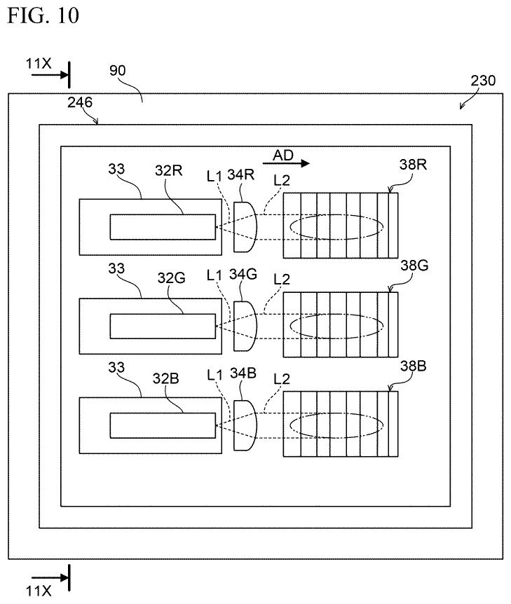

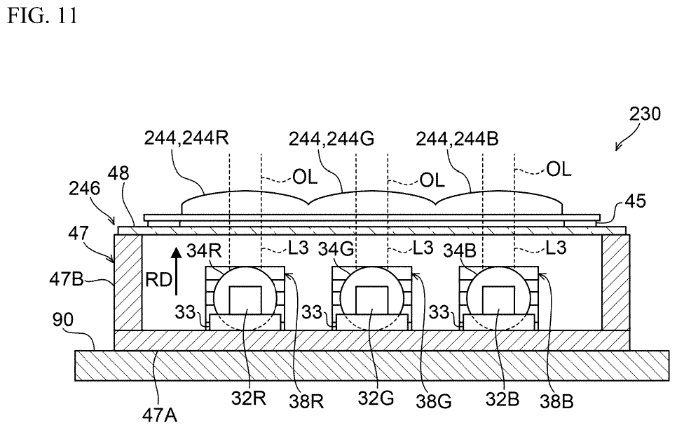

The light-emitting device 230 is now described in detail. FIG. 10 is a schematic plan view illustrating the light-emitting device 230 according to the present embodiment. In FIG. 10, a second lens 244, the lid 48, and the like of light-emitting device 230 are not illustrated. FIG. 11 is a schematic cross-sectional view taken along line 11X-11X in FIG. 10. FIG. 11 illustrates the second lens 244, the lid 48, and the like, which are not illustrated in FIG. 10.

As illustrated in FIGS. 10 and 11, the light-emitting device 230 includes a plurality of light sources 32, a plurality of first lenses 34, and a plurality of light-reflecting parts 38. The light-emitting device 230 further includes a plurality of second lenses 244 and a housing 246.

As illustrated in FIG. 10, three light sources 32R, 32G, and 32B are housed in the housing 246. The light sources 32R, 32G, and 32B are disposed in the housing 246 at intervals in a direction orthogonal to the emission direction of the laser light L1.

The housing 246 has three first lenses 34R, 34G, and 34B housed therein. The first lenses 34R, 34G, and 34B are disposed at positions corresponding to the light sources 32R, 32G, and 32B, respectively. That is, each of the first lenses 34 is disposed at a position on which the laser light L1 emitted from a corresponding one of the light sources 32 is incident.

The housing 246 has the three light-reflecting parts 38R, 38G, and 38B housed therein. The light-reflecting parts 38R, 38G, and 38B are disposed at positions corresponding to the first lenses 34R, 34G, and 34B, respectively. That is, each light-reflecting part 38 is disposed at a position where the collimated light L2 collimated by a corresponding one of the first lenses 34 is reflected.

The housing 246 includes the box 47 and the lid 48 closing the opened part of the box 47. The lid 48 is provided with three second lenses 244R, 244G, and 244B. In the present embodiment, as an example, the three second lenses 244R, 244G, and 244B are integrally formed and bonded to the lid 48 via the adhesive layer 45 formed of an adhesive. The present disclosure is not limited to this configuration, and the second lenses 144 may be formed separately from each other and bonded to the lid 48 via the adhesive layer 45. The lid 48 is attached to the box 47 so as to seal the inside of the box 47. The present disclosure is not limited to the configuration described above, and the housing 246 may be compose of a plate-shaped base and a cover covering the base.

The second lenses 244R, 244G, and 244B are disposed at positions corresponding to the light-reflecting parts 38R, 38G, and 38B, respectively. That is, each of the second lenses 244 is disposed at a position on which the reflected light L3 reflected off a corresponding one of the light-reflecting parts 38 is incident.

The light-emitting device 230 is mounted on the substrate 90. The light sources 32R, 32G, and 32B are electrically connected to an electrode layer (not illustrated) included in the substrate 90. Each of the light sources 32R, 32G, and 32B emits the laser light L1 by being supplied with power through the electrode layer of the substrate 90. Also, the light-emitting device 230 may include the substrate 90.

An effect of the present embodiment is described below. Effects obtained by the same configuration as the configuration of the first embodiment will not be described.

In the light-emitting device 230 of the present embodiment, a plurality of light sources 32, a plurality of first lenses 34, and a plurality of light-reflecting parts 38 are housed in one housing 246. Thus, in the light-emitting device 230, the size of the display device 220 can be reduced as compared with a configuration in which one light source is housed in one housing. In the light-emitting device 230, a plurality of second lenses 244 are joined to the lid 48 forming the housing 246. Thus, similarly to the light-emitting device 30 of the first embodiment, the light-emitting device 230 of the present embodiment can achieve both ensuring of airtightness of the housing 246 and the effect of causing the angular intensity distribution of the laser light OL to be more uniform.

In the light-emitting device 230 of the present embodiment, the plurality of light sources 32, the plurality of first lenses 34, and the plurality of light-reflecting parts 38 are housed in the one housing 246. This configuration may be applied to other embodiments and modification examples of the present disclosure. For example, this configuration may be applied to the light-emitting device 130 of the second embodiment. In this case, the plurality of light sources 32, the plurality of first lenses 34, and the plurality of light-reflecting parts 138 are housed in the one housing 246.

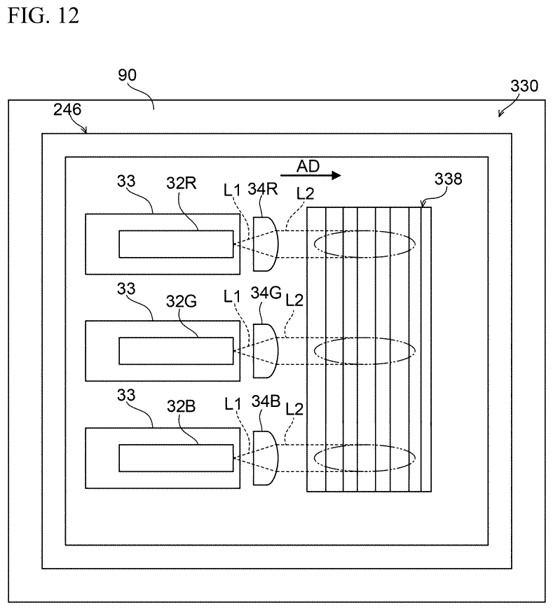

In the light-emitting device 230 of the present embodiment, the plurality of light-reflecting parts 38 corresponding to the plurality of light sources 32 are provided, but the present disclosure is not limited to this configuration. For example, as with a light-emitting device 330 illustrated in FIG. 12, a single light-reflecting part 338 may be provided for the plurality of light sources 32. The light-reflecting part 338 corresponds to the light-reflecting part 38 of the first embodiment with its lateral width extended, and the configuration of the reflecting surface is the same as or similar to that of the reflecting surface 36 of the light-reflecting part 38. In the light-emitting device 330 described above, the number of parts can be reduced. The other configurations of the light-emitting device 330 are the same as or similar to those of the light-emitting device 230 of the third embodiment.

### Other Embodiments

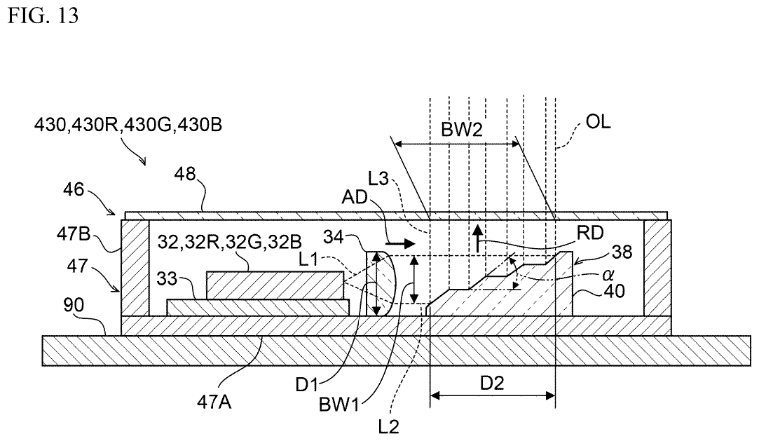

In the light-emitting device 30 of the first embodiment, the second lens 44 is provided on the lid 48 of the housing 46, but the present disclosure is not limited to this configuration. For example, as with a light-emitting device 430 illustrated in FIG. 13, the second lens 44 may not be provided on the lid 48. Specifically, because the optical system 50 of the display device 20 has a function of causing the angular intensity distribution of the laser light OL to be more uniform, the second lens 44 may be omitted depending on the performance required for the display device 20, as in the light-emitting device 430. In a case in which the second lens 44 is omitted, the reflected light L3 transmitted through the lid 48 corresponds to the laser light OL as the output light. In FIG. 13, the light-emitting device 430R includes the light source 32R, the light-emitting device 430G includes the light source 32G, and the light-emitting device 430B includes the light source 32B. The configuration in which the second lens 44 is omitted may be applied to the third embodiment, modification examples, and the like of the present disclosure. For example, in a case in which this configuration is applied to the light-emitting device 230 of the third embodiment, the second lens 244 is omitted.

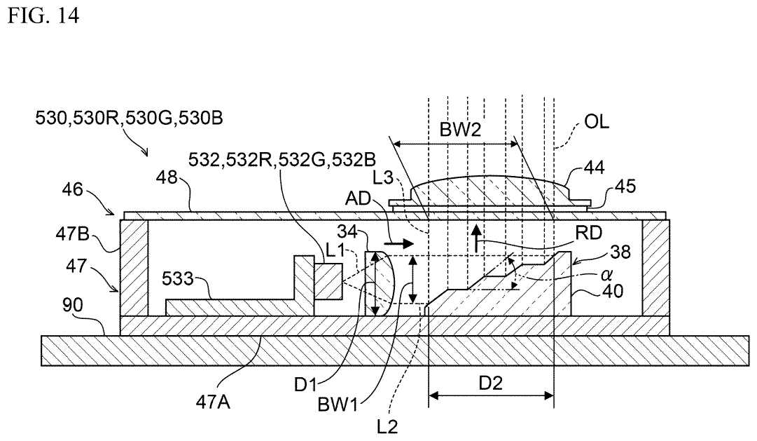

In the light-emitting devices 30, 130, 230, 330, and 430 of the embodiments described above, an edge-emitting semiconductor laser is used as the light source that emits the laser light L1. However, the present disclosure is not limited to this configuration. For example, as in a light-emitting device 530 illustrated in FIG. 14, a surface-emitting semiconductor laser may be used as a light source 532. FIG. 14 is a schematic cross-sectional view illustrating the light-emitting device 530 according to another embodiment. Even when the surface-emitting semiconductor laser is used as the light source 532 as in the light-emitting device 530, the laser light OL with an increased beam diameter can be output in the same manner as or a similar manner to the light-emitting device 30. The light source 532 may be a photonic crystal laser instead of the surface-emitting semiconductor laser. When the surface-emitting semiconductor laser or the photonic crystal laser is used as the light source 532, the light source 532 is fixed to the bottom portion of the housing 46 using a submount 533 having the shape illustrated in FIG. 14. In FIG. 14, the light-emitting device 530R includes the light source 532R, the light-emitting device 530G includes the light source 532G, and the light-emitting device 530B includes the light source 532B.

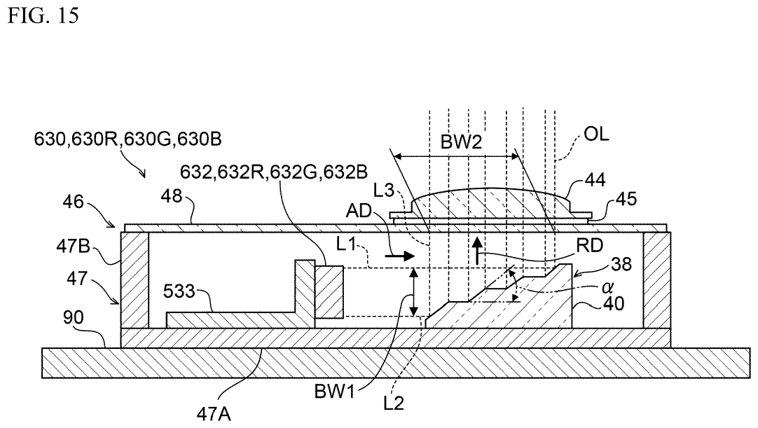

When the edge-emitting semiconductor laser or the photonic crystal laser is used as a light source that emits the laser light L1, the beam divergence angle is reduced. Thus, as in a light-emitting device 630 illustrated in FIG. 15, the first lens 34 may not be provided and accordingly the laser light L1 may not be collimated. That is, when the edge-emitting semiconductor laser or the photonic crystal laser is used as a light source 632 that emits the laser light L1, the first lens 34 may be omitted. In a case in which the first lens 34 is omitted, the laser light L1 is reflected off the light-reflecting part 38 and becomes the reflected light L3. In this case, the beam diameter BW2 of the reflected light L3 is greater than the beam diameter BW1 of the laser light L1.

FIG. 15 is a schematic cross-sectional view illustrating the light-emitting device according to another embodiment. In FIG. 15, the light-emitting device 630R includes the light source 632R, the light-emitting device 630G includes the light source 632G, and the light-emitting device 630B includes the light source 632B. The configuration in which the edge-emitting semiconductor laser or the photonic crystal laser is used as the light source and the first lens 34 is omitted may be applied to the second embodiment, the third embodiment, and the other embodiments, modification examples, and the like of the present disclosure.

In the light-emitting device 30 of the first embodiment, the second lens 44 is joined to the lid 48 via the adhesive layer 45, but the present disclosure is not limited to this configuration, and the lid 48 and the second lens 44 may be integrally formed. That is, the lid 48 and the second lens 44 may be a monolithically formed product. In this case, the number of parts of the light-emitting device 30 can be reduced. The configuration in which the lid 48 and the second lens 44 are integrally formed may be applied to the second embodiment, the third embodiment, and the other embodiments, modification examples, and the like of the present disclosure. For example, in the case in which this configuration is applied to the light-emitting device 130 of the second embodiment, the lid 48 and the second lens 144 are monolithically formed.

The display device 20 of the first embodiment includes the light-emitting device 30, the optical system 50, the image generation element 56, and the imaging optical member 58, but the present disclosure is not limited to this configuration.

For example, the light-emitting device 30 may have some of or all of the functions of the optical system 50. Here, the expression “some of the functions of the optical system 50” refers to the function of the fly-eye lens 52, and the expression “all of the functions of the optical system 50” refers to the functions of both the fly-eye lens 52 and the light-condensing lens 54. In the display device 20, the configuration in which the light-emitting device 30 has a portion of or all of the functions of the optical system 50 may be applied to the second embodiment, the third embodiment, and the other embodiments, modification examples, and the like of the present disclosure.

In the first embodiment, the light-emitting device 30 is used in the display device 20, but the present disclosure is not limited to this configuration. For example, the light-emitting device 30 may be used for an in-vehicle headlight, lighting, or a backlight of a display. The light-emitting devices of the second embodiment, the third embodiment, and the other embodiments, modification examples, and the like of the present disclosure may also be used for a vehicle headlight, lighting, a backlight of a display, or the like.

Although embodiments of the present disclosure have been described above, these embodiments are merely examples, and various modifications can be made without departing from the scope of the present disclosure. It is needless to say that the scope of the present disclosure is not limited to these embodiments.

### REFERENCE CHARACTER LIST

20 Display device
30 Light-emitting device
32 Light source
33 Submount
34 First Lens (example of first lens)
36 Reflecting surface
38 Light-reflecting part
40 Reflecting member
42 Connecting surface
44 Second lens (example of second lens)
45 Adhesive layer
46 Housing
47 Box
47A Bottom portion
47B Frame portion
48 Lid
50 Optical system
52 Fly-eye lens
54 Light-condensing lens
56 Image generation element
58 Imaging optical member
90 Substrate
120 Display device
130 Light-emitting device
136 Reflecting surface
138 Light-reflecting part
140 Reflecting member
142 Connecting surface
144 Second lens (example of second lens)
146 Housing
220 Display device
230 Light-emitting device
244 Second lens (example of second lens)
246 Housing
330 Light-emitting device
338 Light-reflecting part
430 Light-emitting device
530 Light-emitting device
532 Light source
533 Submount
630 Light-emitting device
632 Light source
α Inclination angle
θ Incident angle
AD Traveling direction
RD Traveling direction
BW1 Beam diameter
BW2 Beam diameter
L1 Laser light
L2 Collimated light
L3 Reflected light
OL Laser light
IL Irradiation light
PL Projection light
S Target

What is claimed is:

1. A light-emitting device comprising:
a light source configured to emit laser light;
a lens configured to collimate the laser light; and
a light-reflecting part having a plurality of reflecting surfaces disposed at intervals in a traveling direction of collimated light transmitted through the lens, the plurality of reflecting surfaces being configured to reflect the collimated light in an intersecting direction to the traveling direction, such that a beam diameter of reflected light reflected off the plurality of reflecting surfaces is greater than a beam diameter of the collimated light.

2. The light-emitting device according to claim 1, wherein the light-reflecting part comprises a reflecting member having the plurality of reflecting surfaces.

3. The light-emitting device according to claim 2, wherein the reflecting member further has connecting surfaces extending in the traveling direction, and connecting adjacent ones of the reflecting surfaces.

4. The light-emitting device according to claim 1, wherein:
the plurality of reflecting surfaces have an identical inclination angle relative to the traveling direction; and
the light-emitting device further comprises:
a first lens serving as the lens; and
a second lens configured to cause an angular intensity distribution of the reflected light to be more uniform and to output the reflected light.

5. The light-emitting device according to claim 1, wherein the plurality of reflecting surfaces have different inclination angles relative to the traveling direction.

6. The light-emitting device according to claim 5, further comprising:
a first lens serving as the lens; and
a second lens configured to collimate the reflected light; wherein:
in an angular intensity distribution of output light transmitted through the second lens, a difference in intensity between a central portion and an end portion falls within 20%.

7. The light-emitting device according to claim 4, further comprising:
a housing configured to house the light source, the first lens, and the light-reflecting part; wherein:
the second lens is joined to one component of a plurality of components forming the housing.

8. The light-emitting device according to claim 4, further comprising:
a housing that houses:
a plurality of the light sources configured to emit laser light of different wavelengths,
a plurality of the first lenses respectively corresponding to the plurality of the light sources, and
a plurality of the light-reflecting parts respectively corresponding to the plurality of the first lenses; wherein
a plurality of the second lenses respectively corresponding to the plurality of the light-reflecting parts are joined to one component of a plurality of components forming the housing.

9. A display device comprising:
the light-emitting device according to claim 1;
an image generation element on which light output from the light-emitting device is incident; and
an imaging optical member configured to form an image from light emitted from the image generation element.

10. The display device according to claim 9, wherein an incident angle of light output from the light-emitting device relative to the image generation element is in a range from 10 degrees to 30 degrees.

11. A light-emitting device comprising:
a light source configured to emit laser light;
a lens configured to collimate the laser light; and
a light-reflecting part having a plurality of reflecting surfaces disposed at intervals in a traveling direction of collimated light transmitted through the lens, the plurality of reflecting surfaces being configured to reflect the collimated light in an intersecting direction to the traveling direction, such that a length of a region irradiated with the collimated light emitted to the plurality of reflecting surfaces along the traveling direction is greater than a length of the lens along the intersecting direction.
